(19) United States
(12) Patent Application Publication
(10) Pub. No.: US 2011/0194893 A1
(43) Pub. Date: Aug. 11, 2011

(54) CONTAINER FASTENING ASSEMBLY

(75) Inventor: Cliff WIEBE, Calgary (CA)

(73) Assignee: OPEN RANGE ENERGY CORP., Calgary (CA)

(21) Appl. No.: 12/985,362

(22) Filed: Jan. 6, 2011

(30) Foreign Application Priority Data
Feb. 5, 2010 (CA) 2692016

(51) Int. Cl. B65D 21/02; F16B 5/07

(52) U.S. Cl. 403/300; 220/23.83

(57) ABSTRACT

A connection arrangement for connection of vertically and/or horizontally arranged containers. Each of the containers provides bosses or projections over a collinear pair of which is placed a separate plate. The plate provides matched polygonal apertures to receive the projections. Each of the projections provides an aperture there through to receive a retainer pin or bolt. The pin or bolt abuts the plate when engaged. The arrangement greatly expedites the separation of the containers when desired. The user needs only tap out the retainer pin and pull off the plate. This obviates the use of fasteners which can freeze, rust or become otherwise inoperative or cumbersome.

### TECHNICAL FIELD

The present invention relates to fasteners for modular containers/enclosures and more particularly, the present invention relate to a fastening assembly which is expeditiously removed and assembled to allow separation and assembly of the containers by the user without the need to unfasten bolts etc.

### BACKGROUND OF THE INVENTION

Fastening assemblies of a broad variety have been used for some time in connecting modular containers and panels or segments making up the enclosures or containers. Contributory to the problem with the fastening arrangements known is that they are not designed for simplicity of use and with the least number of parts. It is well known that the nut and bolt or other mechanical arrangements are very often overly complex for the purpose of securing containers together. In the bolt system, the user is often faced with rusted connectors which are difficult if not impossible sometimes to disconnect. This often leads to complete destruction of the fastener and potential damage to the container which elevates costs for wasted time, materials and repairs.

As a further problem, the possibility of attempting to remove nuts from bolts etc. in inclement weather such as freezing weather becomes exceedingly difficult considering the clothing the user must wear to stay warm. The result is that the user often must at least remove hand protection to operate a wrench etc., thus introducing the possibility of frostbite or other exposure.

Tattarn, in British Patent 1,517,312, teaches an improved container. Unfortunately, it is the container that is formed with individual panels. In this manner, some panels have apertures for receiving bosses with additional connection means. Clearly, the container construction itself relies on the fasteners as opposed to the fastening system being used to connect existing adjacently positioned containers.

The prior art is replete with as many variations of fastening systems, all of which are not designed for user ease.

### SUMMARY OF THE INVENTION

One object of the invention is to provide an improved fastening assembly for fastening adjacent pre-existing containers.

A further object of one embodiment is to provide a connection assembly for connecting pre-existing similar containers, comprising, in combination:

a first container and a second container in contact;

first cooperating engagement means projecting from each container of the containers, the first cooperating engagement means being in alignment on containers in contact;

second cooperating engagement means adapted for overlying releasable engagement with the first cooperating engagement means, the second cooperating means having a configuration matched in shape to the first cooperating engagement means, the first cooperating engagement means extending beyond the second cooperating engagement means when the second cooperating engagement means overlies the first cooperating engagement means;

third cooperating engagement means integral with the first cooperating engagement means; and

fourth cooperating engagement means adapted for releasable engagement with the third cooperating engagement means and for retaining the second cooperating engagement means when overlying the first cooperating engagement means, whereby when the first cooperating engagement means receives the second cooperating engagement means and the third cooperating engagement means receives the fourth cooperating engagement means, each container is connected and secured against substantial vertical and horizontal separation.

The arrangement has been found to be particularly simple to use in any weather conditions. The first cooperating engagement means in one embodiment comprises a polygonal boss or projection extending outwardly from each adjacently positioned container and may be on a wall thereof.

The second cooperating engagement means comprises, in one embodiment, a plate adapted to overly the bosses between a pair of adjacent containers. The plate is provided with apertures matched in configuration to the bosses. It is preferred that the shape of the bosses and the plate apertures be selected from a polygonal repertoire; circular arrangements do not provide any protection for horizontal and/or vertical movement between adjacent containers. The polygonal shape is advantageous to avoid such potentially hazardous and damaging movement, since matched configuration between the bosses and plate apertures will preclude such movement.

The bosses are horizontally and vertically collinear to allow any plate to be used over any projections.

With respect to the fourth cooperating engagement means, the same may comprise in one possible embodiment, a pin or L bolt which is simply inserted in to the aperture extending through each boss or any other suitable catch which prevents disengagement of the plate from the boss. It is also important that the fourth cooperating engagement means be very easily removed.

The arrangement is particularly convenient, since a user wishing to disconnect connected containers, simply pushes out the pin from each boss and pulls the plate free of the bosses.

A further object of one embodiment of the present invention is to provide a connection assembly for connecting similar containers, comprising, in combination:

a first container and a second container in contact;

a plurality of projections projecting from each container of the containers arranged in alignment on containers in contact;

a separate plate member adapted for overlying releasable engagement with the projections projecting from each container, the plate having apertures matched in shape to the projections, the projections extending beyond the plate when in overlying relation with the projections;

aperture means extending through the projections; and

retainer means adapted for releasable engagement with the aperture means, whereby when the projections receive the separate plate and the aperture means receives the retainer means, each container is connected and secured against substantial vertical and horizontal separation.

### BRIEF DESCRIPTION OF THE DRAWINGS

FIG. 1 is a perspective view of the container arrangement and fastening assembly according to one embodiment;

FIG. 2 is an enlarged view of the assembly illustrated in FIG. 1;

FIG. 3 is an enlarged view of FIG. 2;

FIG. 4 is a section along line 4-4 of FIG. 3;

FIGS. 5A through 5D illustrate alternate embodiments of FIG. 3;

FIG. 6 is an illustration of an alternate embodiment of the present invention; and

FIG. 7 is an illustration of yet another alternate embodiment of the present invention.

### DETAILED DESCRIPTION OF PREFERRED EMBODIMENTS

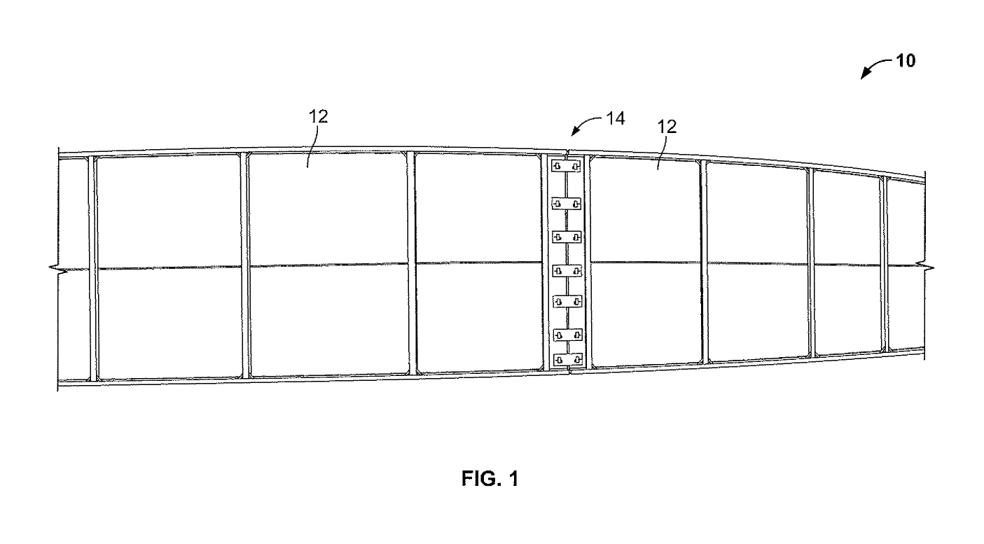

Referring now to FIG. 1, shown is a perspective view of a first embodiment of the present invention. Numeral 10 generally refers to the arrangement. Large containers 12 for storage of, for example, water are desirably connected together for modulation at a site.

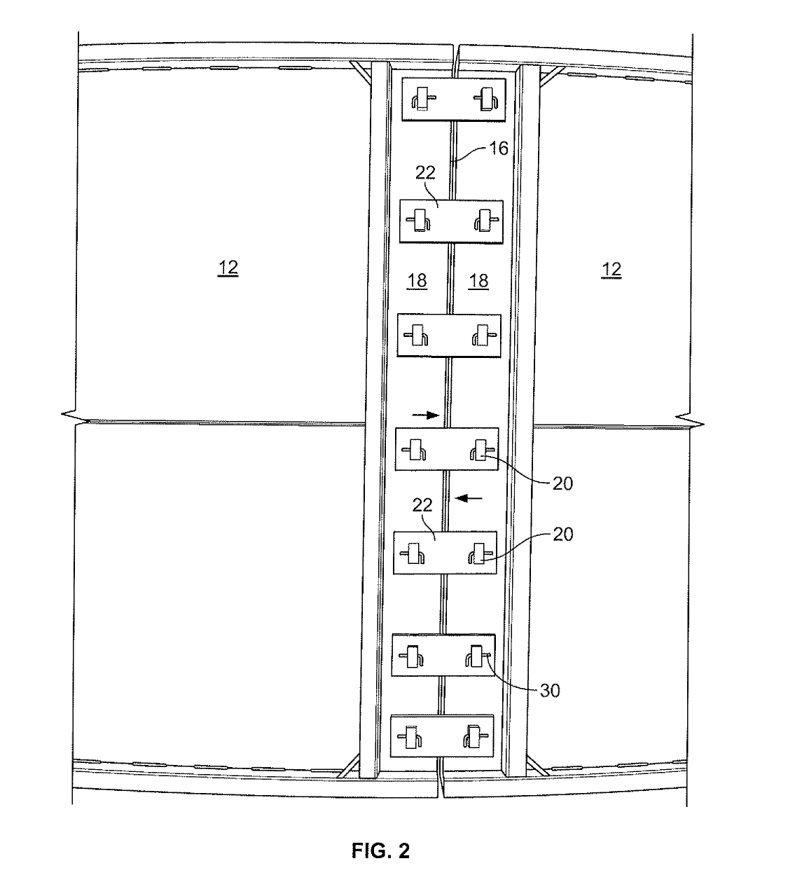

The overall fastening assembly is referenced by numeral 14 and is more detailed in FIG. 2.

Each container 12 is positioned for contact with an adjacent container 12 at an interface 16. A wall or extension 18 is provided on each container 12 for abutment with a similar component from the adjacent container 12. Each wall 18 includes a plurality of projecting bosses 20 extending outwardly in parallel planar relation from wall 18. The bosses 20 function as a first cooperating engagement. The bosses 20 may be welded to the walls 18. The bosses 20 on an individual container 12 are arranged in collinear equidistant relation and are horizontally aligned when walls 18 are abutted between containers 12. The horizontal distance between bosses 20 of adjacent containers, in this embodiment is the same and this is true of the spacing of bosses on an individual container 12.

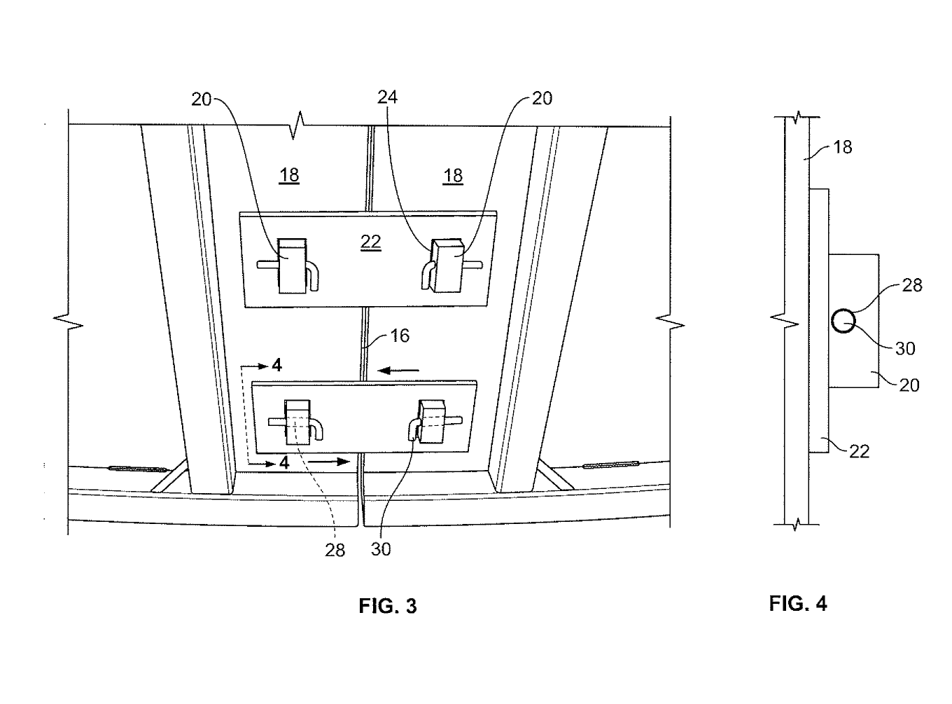

With reference to FIG. 3, shown is an enlarged view of the arrangement. The bosses 20, shown in the example as having a rectangular shape, receive, in overlying relation, a second releasable cooperating engagement member 22. The member 22 is shown in the example as a plate. The plate 22 has spaced apart apertures 24 which receive the bosses 20. The boss 20 shape and aperture 24 are configured for cooperation.

Plate 22 may comprise a similar material of which the containers 12 are made, such as steel. The plate 22 is dimensioned to overlie the interface of abutment, referenced by numeral 16, of the adjacent containers 12. The plate is also dimensioned to be of a lesser thickness than the height of the bosses 20. In this manner, the plate 22 can be loosely retained on the bosses 20 in a parallel plane to the walls 18.

In order to further assist in retaining the plate 22 on the bosses 20, a third releasably engageable cooperating means in the form of an aperture 28 (chain line) cooperates with a fourth releasably engageable cooperating means in the form of, for example, a pin or L-bolt 30. As is illustrated in the example, the pin 30 is received within the aperture 28. The reception is such that the pin 30 abuts the surface of the plate 22. This relationship ensures that the plate 22 remains snugly against the walls 18. The former relationship is depicted in FIG. 4.

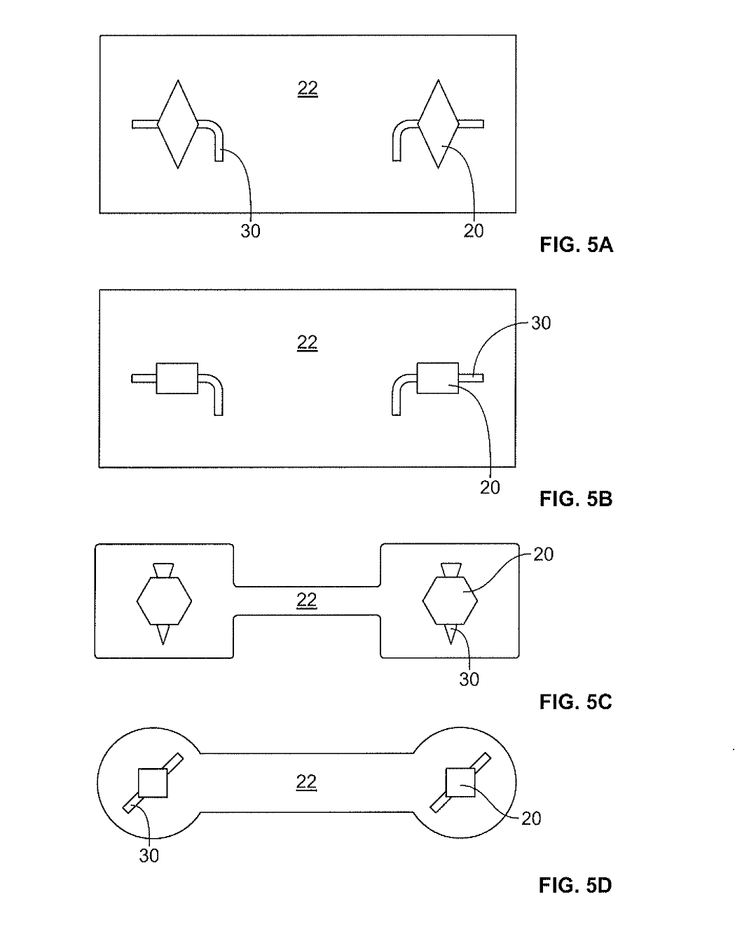

The Figures illustrate the boss 20 shape as a rectangle. This is useful when combined with a keyed or matched configuration in the plate 22 to reduce, if not eliminate, any vertical or horizontal movement of connected containers. Any suitable polygonal shape is envisioned as a possibility. FIGS. 5A through 5D illustrate a number of variations for the plate 22 in terms of the apertures 24 being diamond, square, hexagonal and generally square in shape. The bosses 20 would obviously have a keyed shape for cooperation. In addition, FIGS. 5A through 5D show variations on the shape and disposition of the pins or L bolts 30. The pins or bolts may be inserted into the aperture 28 of the bosses 20 vertically, horizontally or angularly. Further, the pins may be of a varying dimension, i.e. conical, straight, or bent. As a further variation, the plate 22 may comprise any suitable shape variations of which are shown in FIGS. 5C and 5D with a generally dumbbell configuration. Other variations will be appreciated by those skilled.

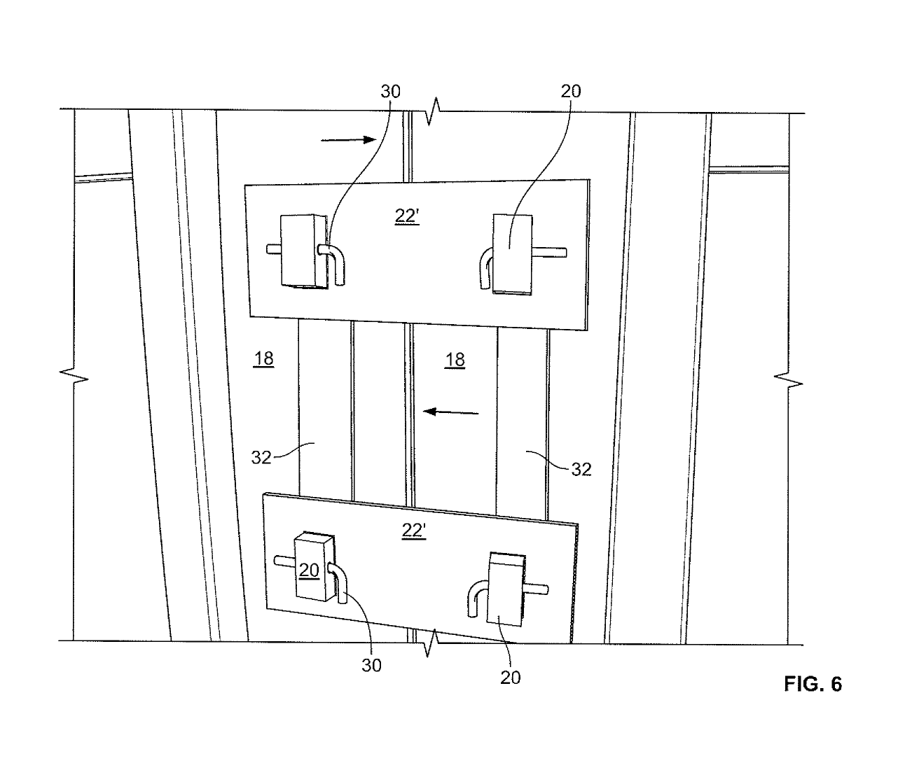

Referring now to FIG. 6, shown is another alternate embodiment of the present invention.

In this embodiment, two bosses 20, a pair from each container 12, are connected by a modified plate 22′. In this embodiment, two plates are joined by joining members 32, shown in the example to be vertical arms. Any suitable configuration to achieve this end is possible and will be appreciated by those skilled. Further, any number of bosses 20 may be connected.

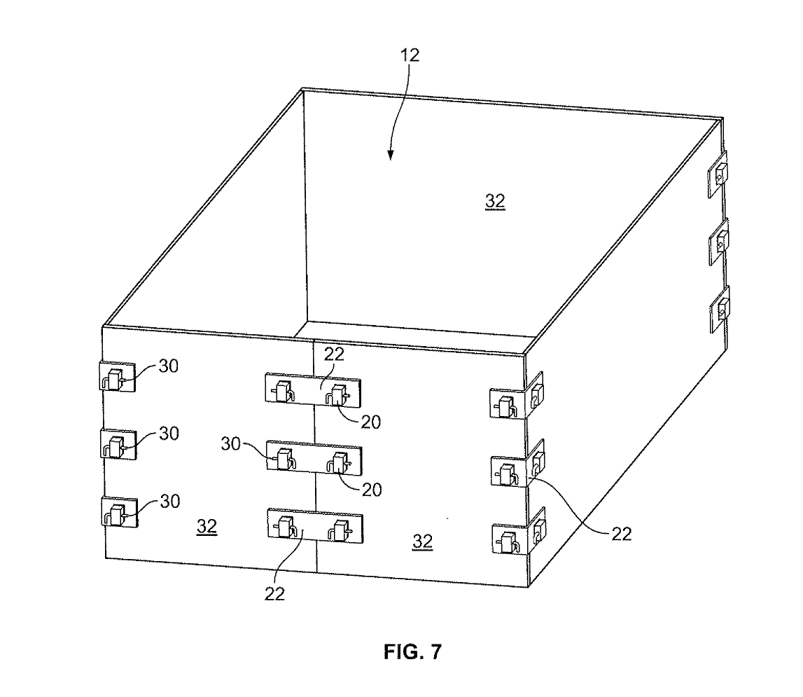

Referring now to FIG. 7, shown is a further variation of the present invention. In this embodiment, the container 12 is formed of a plurality of individual wall segments 32. Each segment includes the bosses 20 which cooperate with an adjacent segment 32 in a manner similar to that discussed with respect to the previous embodiments. Plate 22 joins the adjacent segments. Conveniently, the intersection of two segments at a corner can be easily accommodated by modifying plate 22 by a right angle bend as shown in the illustration. In situations where the angle required is acute or obtuse, the plate will be modified accordingly.

Of particular benefit is the fact that the bosses are attached to a wall of the containers, with no apertures required in the walls. The bosses are positioned to be in a parallel plane with a respective wall to which they are connected with the plate also being in a parallel relationship with the boss over which it lies.

Although embodiments of the invention have been described above, it is not limited thereto and it will be apparent to those skilled in the art that numerous modifications form part of the present invention insofar as they do not depart from the spirit, nature and scope of the claimed and described invention.

I claim:

1. A connection assembly for connecting similar containers, comprising, in combination:
a first container and a second container in contact;
boss means integral with and projecting outwardly from an extension wall of each said container of said containers, said boss means being in horizontal alignment on containers to be connected;
a second cooperating engagement member for overlying releasable engagement with at least a pair of said boss means of containers to be connected, said second cooperating engagement member being independent of each said container, said second cooperating member having a configuration matched in shape to said boss means, said boss means extending beyond said second cooperating engagement member when said second cooperating engagement member overlies said boss means, said second cooperating engagement member when engaged with said boss means overlies a contact interface of connected containers;
third cooperating engagement means integral with said boss means; and
fourth cooperating engagement means adapted for releasable engagement with said third cooperating engagement means and for retaining said second cooperating engagement member when overlying said boss means, whereby when said boss means, connection between containers being effected solely when said boss means receives said second cooperating engagement member and said third cooperating engagement means receives said fourth cooperating engagement means, each said container is connected and secured against substantial vertical and horizontal separation.

2. The combination as set forth in claim 1, wherein said second cooperating engagement member is separate and unconnected to each said container.

3. The combination as set forth in claim 1, wherein each container has a plurality of projecting boss means in vertical spaced relation.

4. The combination as set forth in claim 3, wherein said projecting boss means are in collinear arrangement.

5. The combination as set forth in claim 1, wherein said boss means of said first container and said second container are in a collinear arrangement.

6. The combination as set forth in claim 2, wherein said second cooperating engagement member comprises a removable plate.

7. The combination as set forth in claim 1, wherein a horizontal distance between said boss means between contacted containers is identical to a vertical distance between said boss means of an individual container of said first container and said second container.

8. The combination as set forth in claim 1, wherein at least a boss means between adjacent containers is connected.

9. The combination as set forth in claim 1, wherein said third cooperating engagement means comprises an aperture extending through said boss means.

10. The combination as set forth in claim 1, wherein said fourth cooperating engagement means comprises a separate member unconnected to said container.

11. The combination as set forth in claim 10, wherein said fourth cooperating engagement means comprises an L-shaped pin releasably connectable within said third cooperating engagement means.

12. The combination as set forth in claim 1, wherein said fourth cooperating engagement means, when engaged with said third cooperating engagement means, abuts said second cooperating engagement member.

13. The combination as set forth in claim 1, wherein said first container and said second container are arranged in horizontal disposition.

14. The combination as set forth in claim 1, wherein said first container and said second container are arranged in vertical disposition.

15. The combination as set forth in claim 1, wherein said boss means and said second cooperating engagement member have matched polygonal shapes.

16. A connection assembly for connecting similar containers, comprising, in combination:
a first container and a second container in contact;
a plurality of projections projecting from each wall of each container of said containers arranged in alignment on containers in contact;
a separate plate member for overlying releasable engagement with said projections projecting from each container, said separate plate member being independent of each said container, said plate having apertures matched in shape to said projections, said projections extending beyond said plate when in overlying relation with said projections,
aperture means extending through said projections; and
retainer means adapted for releasable engagement with said aperture means, connection between containers being effected solely when said projections receive said separate plate and said aperture means receives said retainer means, each said container is connected and secured against substantial vertical and horizontal separation.

17. A modular container, comprising:
a plurality of separate container wall segments adapted for releasable connection with each other to form a container or enclosure:
boss means projecting from each said container wall segment of said containers, said boss means being in alignment on each container wall segment;
a second cooperating engagement plate for overlying releasable engagement with at least a pair of said boss means of each juxtaposed wall, said second cooperating engagement member being independent of said container wall segments, said second cooperating plate having a configuration matched in shape to said boss means, said boss means extending beyond said second cooperating engagement means when said second cooperating engagement plate overlies said boss means of juxtaposed walls;
third cooperating engagement means integral with said boss means; and
fourth cooperating engagement means adapted for releasable engagement with said third cooperating engagement means and for retaining said second cooperating engagement member when overlying said first cooperating engagement means, formation of said container being effected solely by said boss means being received in said second cooperating engagement member and when said third cooperating engagement means is received in said fourth cooperating engagement means, whereby said container or enclosure is secured against substantial vertical and horizontal separation.

18. The container as set forth in claim 17, wherein said plate is planar.

19. The container as set forth in claim 17, wherein said plate is angular.
